(19) United States
(12) Patent Application Publication
(10) Pub. No.: US 2015/0220245 A1
(43) Pub. Date: Aug. 6, 2015

(54) BRANDED COMPUTER DEVICES AND APPARATUS TO CONNECT USER AND ENTERPRISE

(71) Applicant: Clear View Productions, Inc., Tinley Park, IL (US)

(72) Inventors: Ronald Wojcik, Frankfort, IL (US); William Lynch, Orland Park, IL (US)

(21) Appl. No.: 14/424,720

(22) PCT Filed: Aug. 27, 2013
(86) PCT No.: PCT/US2013/056739

§ 371 Date: Feb. 27, 2015

Related U.S. Application Data
(60) Provisional application No. 61/693,616, filed on Aug. 27, 2012.

(51) Int. Cl. G06F 3/0481; H04L 29/08; G06Q 30/06; G06F 3/0484

(52) U.S. Cl. CPC G06F 3/04817; G06F 3/04842; H04L 67/02; G06Q 30/0641

(57) ABSTRACT

The present disclosure relates generally to computer devices and/or apparatus (e.g., computer tablets, mobile computers, smart mobile phones, other mobile computing devices, etc.). More particularly, the present disclosure pertains to the use of methods, programs, and systems for branding computer devices and/or apparatus (e.g., computer tablets, mobile computers, smart mobile phones, other mobile computing devices, etc.) to connect customers and an enterprise (e.g., retailer, non-profit, university, etc.).

### CROSS-REFERENCE TO RELATED APPLICATION

This application claims the benefit of U.S. Provisional Patent Application Ser. No. 61/693,616 filed 27 Aug. 2012, entitled “BRANDED COMPUTER DEVICES AND APPARATUS TO CONNECT USER AND ENTERPRISE,” which is incorporated herein by reference in its entirety.

### TECHNICAL FIELD

The present disclosure relates generally to computer devices and/or apparatus (e.g., computer tablets, mobile computers, smart mobile phones, other mobile computing devices, etc.). More particularly, the present disclosure pertains to the use of methods, programs, and systems for branding computer devices and/or apparatus (e.g., computer tablets, mobile computers, smart mobile phones, other mobile computing devices, etc.) to connect customers and an enterprise (e.g., retailer, non-profit, university, etc.).

### SUMMARY

In one or more embodiments herein, a method provides a custom user interface on a computer device (e.g., computer tablets, mobile computers, smart mobile phones, other mobile computing devices, etc.). For example, the computer device may include memory (e.g., data storage apparatus such as volatile or non-volatile memory and/or storage elements), a screen, and a processing apparatus. The method may include providing a server (e.g., a server having memory and processing apparatus). The server memory may be configured to store, or include, information associated with one or more enterprises (e.g., retailers, non-profits, universities, companies, etc.). The information may include at least identification information corresponding to each of the one or more enterprises (e.g., serial numbers of computer devices associated with a particular retailer or enterprise, pin codes associated with a particular retailer or enterprise, etc.) and a plurality of graphical elements (e.g., graphical depictions, such as depictions that are the same as or similar to icons for particular device applications, such as, depictions for storefronts such as music storefronts, tv/movie storefronts, prescription services, loyalty programs, coupon services, etc.) associated with each of the one more enterprises to be delivered to a defined location on a screen of a computer device. For example, each of the one or more of the graphical elements may be associated with a web address or an address of the server (e.g., to facilitate downloading of the device application represented thereby). Further, for example, each of the one or more of the graphical elements may represent a device application.

Further, the method may include providing a user interface installation program (e.g., a custom user interface installer) storable on the memory (e.g., data storage apparatus such as volatile or non-volatile memory and/or storage elements) of a computer device (e.g., computer tablets, mobile computers, smart mobile phones, other mobile computing devices, etc.). Still further, the method may include communicating with the server, using the user interface installation program, to identify an enterprise of the one or more enterprises as being associated with the computer device based at least on, for example, the identification information (e.g., stored in the server storage apparatus) and downloading and placing a plurality of graphical elements associated with the identified enterprise at a defined location on a screen of the computer device. For example, one or more of the plurality of graphical elements placed at the defined location on the screen may operate as placeholders corresponding to downloadable device applications. Interaction, by a user of the computer device, with a graphical element operating as a placeholder (e.g., user touching the graphical element on the screen) may initiate downloading a downloadable device application corresponding to the placeholder (e.g., the placeholder is merely a marker or screen saver element selectable by the user to download the device application, such as, for example, a device application desired by a retailer and/or enterprise to connect the retailer and/or enterprise with the user). Further, for example, one or more of the plurality of graphical elements placed at the defined locations on the screen may operate as shortcuts for launching, or starting, device applications. Interaction, by a user of the computer device, with a graphical element operating as a shortcut (e.g., user touching the graphical element on the screen) may initiate, start, or launch the device application (e.g., after the device application has already been downloaded and/or installed).

A system of providing a custom user interface on a computer device (e.g., a computer device including memory, a screen, and a processing apparatus) may include a server (e.g., having memory and processing apparatus). The server memory (e.g., data storage apparatus such as volatile or non-volatile memory and/or storage elements) may include information associated with one or more enterprises (e.g., identification information corresponding to each of the one or more enterprises, a plurality of graphical elements associated with each of the one more enterprises to be delivered to a defined location on a screen of a computer device, etc.). For example, in one or more system embodiments, each of the one or more graphical elements may be associated with a web address or an address of the server. Further, the system may include a user interface installation program (e.g., a custom user interface installer storable on memory of a computer device). For example, the user interface installation program, when executed by a processing apparatus of the computer device, may be operable to identify an enterprise of the one or more enterprises as being associated with the computer device via communication with the server based at least on the identification information, to communicate with the server to download and place a plurality of graphical elements associated with an identified enterprise at a defined location on a screen of the computer device (e.g., one or more of the plurality of graphical elements may be placed at a defined location on the screen operating as placeholders corresponding to downloadable device applications), and to download a downloadable device application corresponding to a placeholder upon user interaction with a graphical element operating as the placeholder.

Further, another system of providing a custom user interface on a computer device may include a server (e.g., including memory and processing apparatus, wherein the server memory may include, or be configured to store, information associated with one or more enterprises). The information may include at least identification information corresponding to each of the one or more enterprises and a plurality of graphical elements associated with each of the one more enterprises to be delivered to a defined location on a screen of a computer device. The defined location on the screen may be an enterprise space located in a region separate from a user space. Further, for example, the system may also include a user interface installation program (e.g., a custom user interface installer storable on memory of a computer device), wherein the user interface installation program, when executed by a processing apparatus of the computer device, is operable to identify an enterprise of the one or more enterprises as being associated with a computer device via communication with the server based at least on the identification information and communicate with the server to download and place a plurality of graphical elements associated with an identified enterprise in the enterprise space of a screen of a computer device. One or more of the plurality of graphical elements placed in the enterprise space of the screen may operate as placeholders corresponding to downloadable device applications. The plurality of graphical elements may be displayable in the enterprise space at the same time as a user space of the screen displays one or more icons corresponding to user selected applications (e.g., GMAIL, FACEBOOK, etc. which may not be associated with the retailer and/or enterprise).

In one or more embodiments of the systems or methods herein, one or more of the plurality of graphical elements placed at the defined location on the screen operating as placeholders corresponding to downloadable device applications may be non-removable (e.g., undeletable by a user, not capable of being un-installed by a user, etc.).

In one or more embodiments of the systems or methods herein, the computer device, using the user interface installation program (e.g., a tablet computer having the custom user interface installed thereon), may be configured to call back and/or reconnect with the server on a periodic or non-periodic basis to monitor and/or update the plurality of graphical elements associated with the identified enterprise (e.g., weekly, monthly, before the release of new sales, etc.).

In one or more embodiments of the systems or methods herein, downloading and placing (e.g., locating, etc.) the plurality of graphical elements associated with the identified enterprise at a defined location on a screen of the computer device may be provided without user intervention (e.g., multiple placeholders may be automatically downloaded quickly without the user having to interact with each of them individually). In other words, the updating of the graphical elements associated with the identified enterprise may be described as being automated or automatic.

In one or more embodiments of the systems or methods herein, at least one of the plurality of graphical elements is auto-launched to convert the graphical element placed at the defined location on the screen operating as a placeholder to a device application upon first interaction with the graphical element by a user (e.g., an icon associated with the device application and identical to the graphical element may replace the graphical element after such first interaction). For example, initiation (e.g., touching) of the placeholder may download and install a device application associated with the placeholder and transform the placeholder into a graphical link to launch the device application.

In one or more embodiments of the systems or methods herein, the computer device, using the user interface installation program, may provide a screen on the computer device that includes a retailer and/or enterprise space (e.g., a retailer and/or enterprise space that may display a plurality of graphical elements associated with the retailer and/or enterprise) and a user space separate from the retailer and/or enterprise space (e.g., a user space that may display one or more icons corresponding to user selected applications at the same time the plurality of graphical elements associated with the retailer and/or enterprise are displayed).

Further, a computer tablet may include a screen, wherein the screen includes a retailer and/or enterprise space (e.g., a retailer and/or enterprise space that may display a plurality of graphical elements associated with the retailer and/or enterprise, wherein one or more of the plurality of graphical elements may operate as placeholders corresponding to downloadable device applications) and a user space (e.g., a user space that displays one or more icons corresponding to user selected applications).

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 depicts a system to perform a connection between one or more customers and one or more enterprises.

FIG. 2 depicts an exemplary method for device registration.

FIG. 3 depicts an exemplary general method for a downloader.

FIG. 4 depicts an exemplary process for controlling installation of packages and shortcuts of the method of FIG. 3.

FIG. 5 depicts an exemplary process for checking updates of the method of FIG. 3.

FIG. 6. depicts an exemplary method for a shortcuts creator.

FIG. 7 depicts an exemplary general method for a launcher.

FIG. 8 depicts an exemplary process for an exemplary timer of the launcher of FIG. 7.

FIG. 9 depicts exemplary processes for blocked shortcuts and updating shortcuts of the launcher of FIG. 7.

FIG. 10 depicts an exemplary method for a desktop application for administering an account.

FIG. 11 depicts an exemplary user interface.

FIG. 12 depicts another exemplary user interface.

### DESCRIPTION OF THE EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

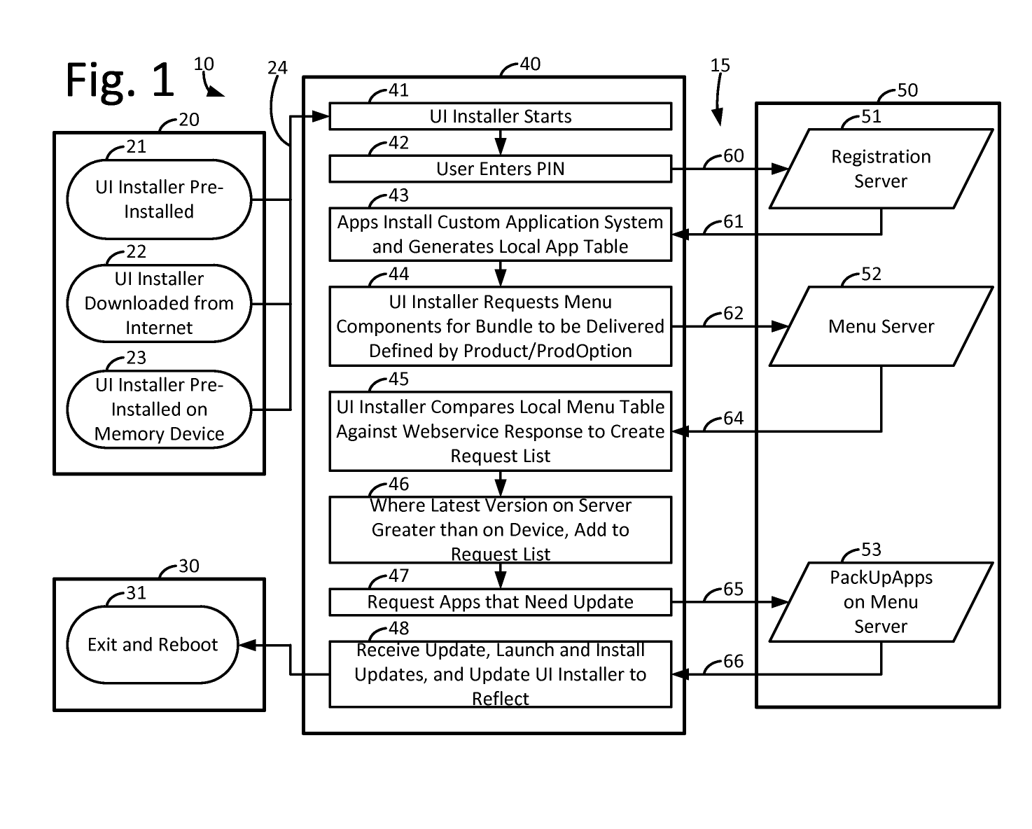

Exemplary methods, systems, and devices shall be described with reference to FIGS. 1-12. It will be apparent to one skilled in the art that elements or processes from one embodiment may be used in combination with elements or processes of the other embodiments, and that the possible embodiments of such methods, systems, and devices using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

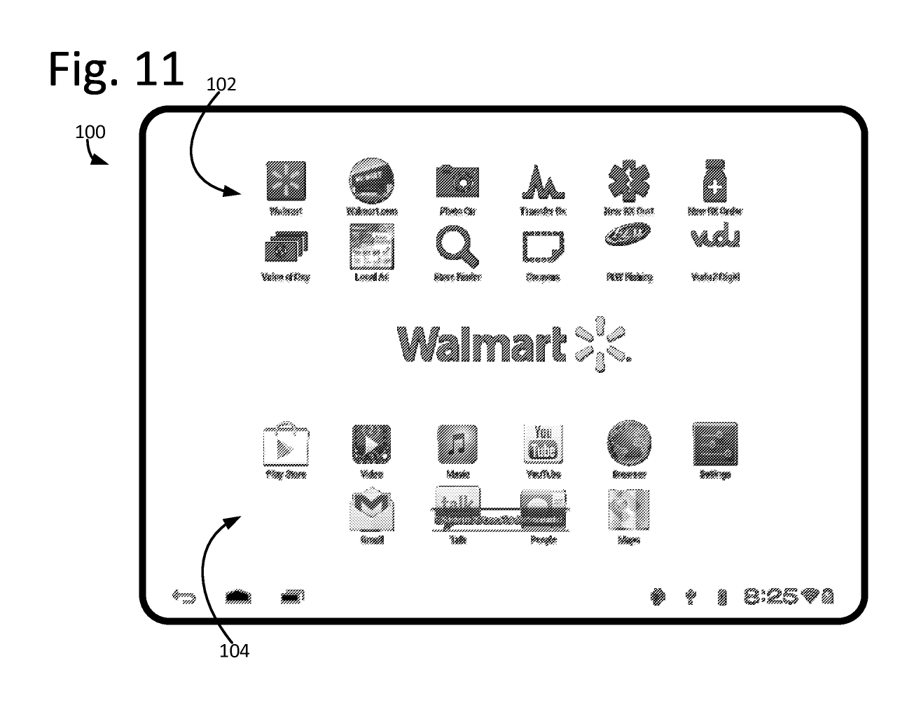

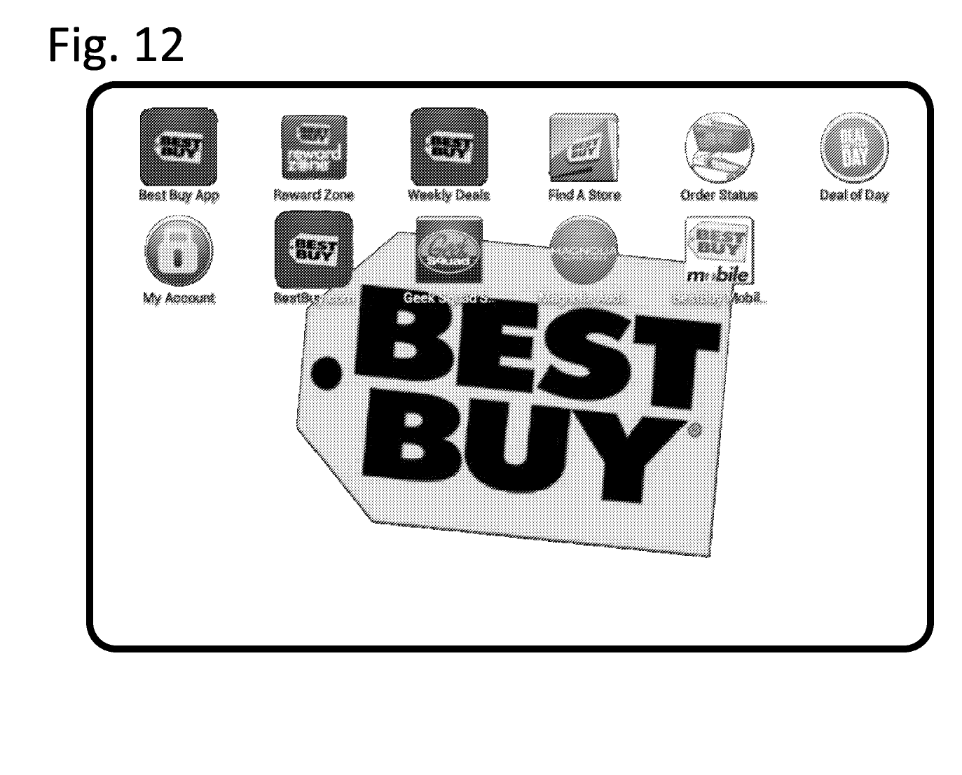

A system and/or a process (e.g., method) to provide a custom user interface on a computer device 40 (see, e.g., the user interfaces depicted in FIG. 11, a WALMART-branded tablet, and FIG. 12, a BESTBUY-branded tablet) is shown in FIG. 1. In one embodiment, the computer device 40 may be a computer tablet. However, the computer device 40 may be any other computing device such as a mobile phone, an ultraportable computing device, smart phone, portable music player, portable internet viewer, portable reader, etc., such as an APPLE IOS device, GOOGLE ANDROID device, MICROSOFT WINDOWS device, BLACKBERRY device, HP PALM device, etc.

In one or more embodiments, the system or process may convert a standard tablet or other device (e.g., a standard ANDROID tablet or smart phone) into a retailer's own custom version over the internet, or another network, by using a combination of custom code delivered or residing on the tablet and synchronization with a cloud-based server. Further, in one or more embodiments, the system or process may employ a no-step or a one-step process to initiate and eliminate multiple entries associated with delivering links and applications to a tablet. Further, in one or more embodiments, the system or process may place deliverables (e.g., graphical elements representing web links, mobile web links, ANDROID APK (application package files) applications, screensavers, etc.) in a specific placement on the tablet's screen and lock down some, all, or none of the deliverables or elements. Still further, in one or more embodiments, the system or process may implement a call-back feature to repeat various steps (e.g., such as identification, downloading, delivering, placing steps such as those set forth herein in a logical fashion) periodically such as, e.g., daily, weekly, monthly, quarterly or annually. Yet further, in one or more embodiments, the system or process may have the ability to install all the deliverables (e.g., graphical elements and/or device applications) without user intervention and may employ a unique auto launch feature to convert a deliverable from a graphical element (e.g., similar to an icon) to an application on first usage (e.g., replacing the graphical element with a like icon associated with the device application). Still further, in one or more embodiments, the system or process may be able to collect the serial number of the computer device (e.g., computer tablets, mobile computers, smart mobile phones, other mobile computing devices, etc.) and pass it through to the retailer or enterprise as a variable index field (e.g., allowing the retailer or enterprise to pinpoint the identity of the owner without exposing that information to a third party, such as owner of the server, allowing the retailer or enterprise to identity where, or from what retailer, the device was sold, etc.). Still further, in one or more embodiments, the system or process may be able to collect an identification number (e.g., input by a user, read by a bar scanner, etc.) and pass it through to the retailer or enterprise as a variable index field (e.g., allowing the retailer or enterprise to pinpoint the identity of the owner without exposing that information to a third party, such as owner of the server, allowing the retailer or enterprise to identity where, or from what retailer, the device was sold, etc.). Still yet further, in one or more embodiments, the system or process may have the ability to communicate with (e.g., push data to) the tablet, or other computing device, in graphical form using an RSS data feed, XML data feed, or any other protocol or type of communication method.

As shown in FIG. 1, in one or more embodiments, the system or process 10 includes providing the custom user interface installation program to the device 40 in one or more ways as shown generally by block 20. For example, a Customer User Interface Installer (CI) System and/or APK may be delivered via at least one of three methods. For example, the CI system and/or APK may be a trusted program embedded in the setup sequence and firmware of the computer device (e.g., computer tablets, mobile computers, smart mobile phones, other mobile computing devices, etc.) that initiates the CI System and/or APK upon first usage 21. Further, for example, the CI system and/or APK may be delivered off of a cloud based server through a web link (e.g., from a cloud based server) 22. Still Further, for example, the CI system and/or APK may be “auto launched” off of external memory or media device (e.g., flash drive, memory card such as SECURE DIGITAL (SD) card, etc., such as may be given away, or provided, by a retailer/enterprise) 23. In other words, a user may receive the tablet with a Customer User Interface Installer (CI) pre-installed, a user may download a CI system from a website, and/or a user may receive a tablet with a CI preinstalled on a SD memory card.

Upon delivery of the custom user interface installation program (e.g., the APK, the CI, etc.) and its initial launch 41, a cloud server 50 may then associate the device 40 (e.g., tablet) with a particular enterprise (e.g., retailer, reseller, etc.) via one or methods. For example, such methods may include one of the following three methods: (1) Auto extracting the serial number from the device data structure and passing it 60 to a registration server 51 in the cloud server 50; (2) Displaying a registration screen requiring user input of the serial number 42 and passing that data 60 to a registration server 51 in the cloud server 50; and (3) Displaying a registration screen requiring user input of a provided unique registration code (e.g., personal identification number or code) 42 into the device and passing that 60 data to a registration server 51 in the cloud server 50.

For example, the registration server 51 may include identification information in memory (e.g., data storage apparatus) thereof. For example, in either of the above scenarios, the registration server 51 of the cloud server 50 memory may include a sequence of serial numbers pre-associated with a particular enterprise (e.g., retailer). In one embodiment, the APK (e.g., the CI) may perform a handshake with the registration server 51 to establish the identity of the device/tablet 40.

The device 40 may communicate, using the CI, with the server 50 via any network 15 including, but clearly not limited to, the internet or the web, a wireless network, a local area network, a wide area network, etc. Such communication over different networks may occur at different times for different purposes.

Upon the first usage of the APK (e.g., the first use of the CI), a blank library is delivered to the tablet in one step which is transparent to the end user and requires no user intervention. For example, the following may be accomplished with the blank library:

(1) The blank library may allow a valid target separate from the rest of the tablet; and
(2) The library may use a numeric process to link each deliverable with a slot number in ascending order.

The initial library once delivered may be instructed to synchronize with the cloud server using logic, whereby the cloud overrides and/or updates the contents of the tablet only upon this first connection. Thereafter, only updates may be provided such as described above with reference to FIG. 1.

The contents of the cloud server 50 may contain graphic depictions or icons to be delivered to precise and/or default locations on the device or tablet 40 (e.g., an enterprise space on the screen apart from, for example, a user space). In other words, the cloud server 50, or memory thereof, may include graphical elements associated with an enterprise (e.g., a retailer) to be delivered to precise locations on the tablet (e.g., an enterprise space on the device screen separate from a user's space).

For example, as shown in FIG. 11, an exemplary interface 100 may include an enterprise space 102 for the graphical elements associated with the enterprise. In this example, the enterprise is WALMART, and the graphical elements associated with WALMART depicted in the enterprise space 102 are the following: WALMART, Walmart.com URL link, Photo Center, Transfer Rx, New RX Customer, New RX Order, Value of the Day, Local Ad, Store Finder, Coupons, FLW Fishing, and VUDU Digital Video. In this example, separate from the enterprise space 102 is the user space 104, which in this example is shown below the enterprise space 102. The user space 104 may contain the apps installed by the operating system provider (e.g., GOOGLE) and/or installed by the user such as, e.g., Play Store, Video, Music, YOUTUBE, Browser, Settings, GMAIL, GTALK, People, and Maps. Additionally, as shown, the wallpaper or background of the device 40 may include an enterprise or retailer trademark such as WALMART as shown in FIG. 11.

The underlying data for each graphical element (e.g., icon) may include a web location or an address to/on the cloud server 50 and no other content. In this way, the device or tablet 40 can be populated with multiple graphical elements (e.g., icons operating as placeholders) in one step. Typically, the delivery of an actual APK requires that the device or tablet 40 may require a user to initiate a request, acknowledge a verification of the request, and confirm the installation. The process herein, at least in one embodiment, eliminates these multiple steps and delivers a way to install each APK of a plurality of APKs in a single batch process (e.g., automatically) that specifically places the APK or deliverable in a designated place on the tablet screen.

The enterprise (e.g., retailer, retailer, etc.) may specify which, if any icons, are flagged as being non-removable (e.g., incapable of being user un-installed) and the APK may render them in that manner.

In one or more embodiments, because the target library on the device (e.g., computer tablets, mobile computers, smart mobile phones, other mobile computing devices, etc.) is never used for any function other than cloud synchronization, this initial logic contains a logical and verifiable way of assuring that the contents sent to the table via the internet match that on the cloud server.

In one or more embodiments of the systems or methods herein, the computer device 40, using the CI (e.g., a tablet computer or smart enabled mobile phone having the CI installed thereon), may call back and reconnect with the server 50 on a periodic or non-periodic basis to monitor and/or update the plurality of graphical elements (or previously-installed applications) associated with the identified enterprise (e.g., weekly, monthly, before the release of new sales, etc.). For example, such call backs may provide information to update applications, place new graphical elements operating as placeholders for device applications, etc. Further, for example, the device 40 may reconnect to the server 50 periodically to update the graphical elements. Such an update may include updating perpetual graphical elements, adding new graphical elements, and/or removing expired/old graphical elements. For example, the system allows the server 50 to time define graphical elements, meaning that the underlying content (e.g., graphically represented on the device) can expire (e.g., after a selected period of time).

For example, in one embodiment, the CI APK may set a call-back feature that instructs the tablet to reconnect to the cloud server 50 on a periodic basis. This is determined initially on the tablet and may then be changed by the cloud server. For example, the tablet may reconnect on a daily, weekly, monthly, quarterly, or annual basis.

Such reconnection may be done transparently to the user and in the background over the network 15 (e.g., the internet).

In one or more embodiments, upon call back, the device or tablet 40 and the server 50 may connect and sync through a new set of hierarchal and logical steps. If the tablet owner or user has deleted a removable icon, application, web link, mobile web link, or ANDROID APK, then the cloud server 50 may detect the removal and may not send the deliverable from this point on. As such, the system 10 may provide a method such that a user may make changes that will be recognized, and thus not over-written.

If the retailer or retailer desires to remove a graphical element, an icon or its associated application, then the APK on the device or tablet 40 will instruct the device or tablet 40 to delete that icon. If new deliverables are associated with the device or tablet 40, they may be added in ascending order to the cloud and synced to the tablet upon call back.

Such steps may be performed in any suitable sequence and can be repeated at each call back interval (e.g., the sequence of the above three actions may repeat at each call back interval).

In addition to the above logic, a time based interval management system may be employed. The cloud server 50 may have additional logic that associates an icon with a time frame. Upon the starting time point, the icon (e.g., a retail offer) may manifest itself upon the device or tablet 40. At (or after) the expiration point, the cloud server may remove the icon and the IC APK may remove it from the tablet's screen as well.

In one or more embodiments of the systems or methods herein, at least one of the plurality of graphical elements is auto-launched to convert the graphical element placed at the defined location on the screen operating as a placeholder to a device 40 application upon first interaction with the graphical element by a user (e.g., an icon associated with the device application and identical to the graphical element may replace the graphical element after such first interaction).

For example, as described herein, after the CI system and/or APK has been registered (e.g., the serial number of the tablet has been collected, the enterprise, such as a retailer, has been identified, etc.) and initiated the request for icons from the device or tablet 40 to the cloud server 50, the cloud server 50 may batch all the graphical elements (e.g., which may be in the form of icons) and may deliver them to the screen of the device or tablet 40. The icons (e.g., empty graphical elements or icons) are placeholders (e.g., place marks or addresses to a location on the cloud server). To avoid multiple steps and consolidate the process to one step, the placeholder icons (e.g., upon initiation) may now auto run and convert from an address to a device application (e.g., an application associated with a retailer and/or enterprise).

For example, the user may initiate (e.g., by touching it) an icon (e.g., interact with the placeholder icon or graphical element) and the server 50 may deliver the application seamlessly. The application may automatically run and replace the placeholder icon shell with an actual application itself (e.g., the actual application icon). In one or more embodiments, after the first fetch of the application, the application program may now reside on the device or tablet 40 and may be initiated using the same graphical depiction. The icon or graphical depiction now has the actual program in the place of an address on the cloud server 50. The placeholder graphical depiction may be the same or be different than the icon of the actual application.

This may work in conjunction with the custom library as it allows the retailer a way to remove a location from the cloud server 50 and replace the link with a new shell now linked to an application. Thus, the process allows for the retailer to change underlying technologies and update the new deliverables in a time specific manner from a central location. This may all be based upon the sync method, custom library, APK, cloud server and icon conversion methods described herein.

The cloud server 50 may initiate a graphical delivery of data initiated by the enterprise (e.g., a retailer). This channel may be turned on via a time specific throw from the cloud server 50 to a new location on the custom library. The data may be delivered via a RSS data field or feed (or, e.g., a XML data field or feed, and/or any other data communication method or protocol) and can include graphics and text. Via the call back and sync hierarchy, the user may eliminate an icon associated with this RSS feed and the cloud server may remove this feature set from that point forward.

One or more embodiments of the systems and/or processes described herein provide for various implementations of various features. For example, such features may include: over the air conversion to customize a tablet from the initial format to a custom version by connecting the device/tablet 40 and the cloud server 50; a time specific use of a custom library on the device/tablet 40 in conjunction with logic tools on the cloud server 50 and the CI system; a call-back feature as used with the custom library; a conversion of a graphical placeholder icon to an actual ANDROID application in one click and the ability to replace a web address with a program; creation of a variable field passed in an identifiable form to the retailer and/or enterprise that is used to identify the device/tablet 40 owner only to the retailer and/or enterprise; and use of the time specific cloud delivery, custom library and the initiation or discontinuation of a graphical data feed back to the tablet.

In one exemplary embodiment of providing a custom user interface, as shown in device 40 and server 50, upon delivery of the CI 24, the CI is started 41, a user may enter a personal identification number (PIN) (e.g., optional registration data) in a registration webservice 42. Such information is provided to the registration server of the server 51 of the cloud server 50 (e.g., the registration server 51 then identifies an enterprise, such as a retailer, associated with the device/tablet 40, such as by a method described herein) and a registration response is provided back 61 to the device/tablet 40. For example, the registration response 61 may be a retailer custom application system such that a local app table is generated 43 by the device 40.

Further, as shown in FIG. 1, the CI on the device 40 may request information from the server 50 (e.g., components such as graphical elements positionable on the screen of the device as placeholders for device application that may be downloaded later). For example, in one exemplary embodiment as shown in device 40 and server 50, the CI may request retailer/enterprise menu components for a bundle to be delivered that is defined, for example, by a particular product/product option 44. Such a request 44 (e.g., Bundle Components and Version Webservice) is sent to 62 and may be received by the menu server 52 (e.g., retailer menu server, enterprise menu server, etc.) of server 50. The menu server 52 of cloud server 50 may respond 64 (e.g., with bundle components and version response). The CI then may compare the local menu table (e.g., previously provided on the device 40) against the webservice response 64 from the retailer menu server to determine differences and put together a request list (e.g., graphical elements not yet downloaded to the device 40) 45. For example, for all applications where the latest version on the server is greater (e.g., newer) than on the device 40, the applications are added 46 to the list of applications to be updated on the device 40.

Further, as shown in the exemplary embodiment of FIG. 1, a request for applications which need to be updated 47 is provided 65 to a pack-up apps process on the menu server 53 of the server 50. For example, a call may be made to provide menu update and pack-up apps (e.g., a call to the pack-up apps process on the menu server 53). A response 66 from the server 53 including a generated menu update and applications contained is provided to the device 40. The update may be received by the device 40, which then updates, launches, and installs contained updates to the application files (e.g., APK's), and then updates the local menu table to reflect newly installed component files (e.g., APK's) 48.

Still further, as shown in the exemplary embodiment of FIG. 1, an exit 31 is performed as shown generally by block 30, and the device 40 may reboot to auto start the new updated custom menu.

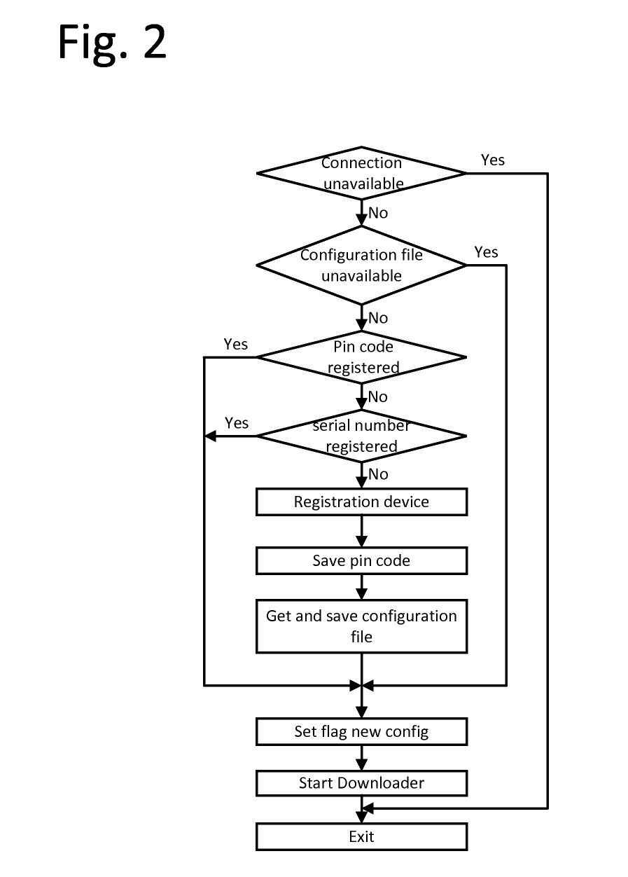

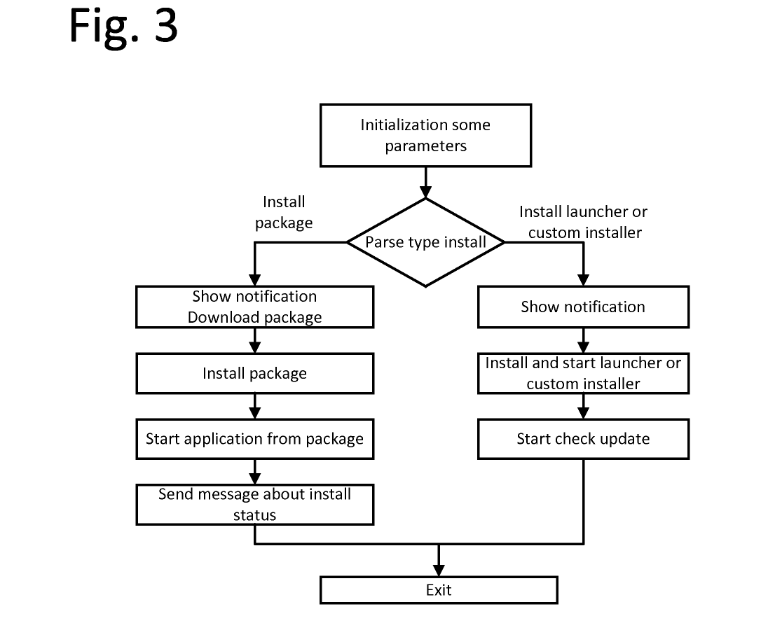

More specific methods and processes used to implement the exemplary custom user interface on device 40 to provide the user interface upon first usage and to update the custom user interface on device 40 are depicted in FIGS. 2-10. For example, an exemplary method for device registration is depicted in FIG. 2. Generally, upon initial startup, an exemplary device registration process may start and an xml file may be copied to a downloader process, which may also be initiated (such as described herein with respect to FIGS. 3-5).

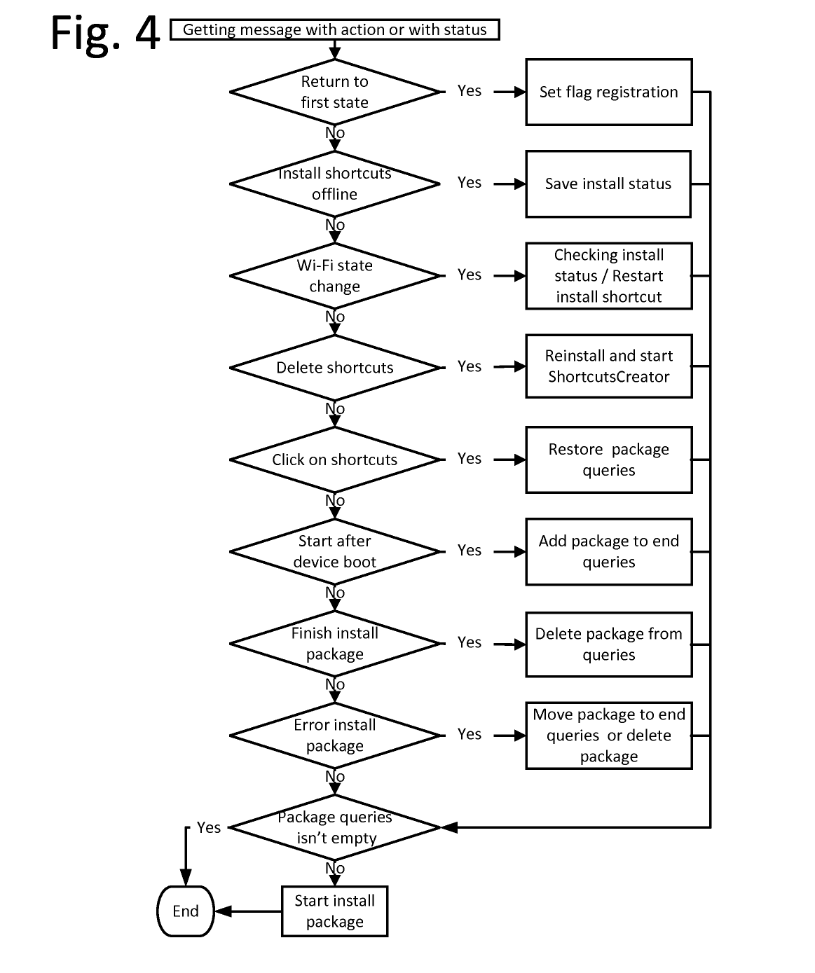

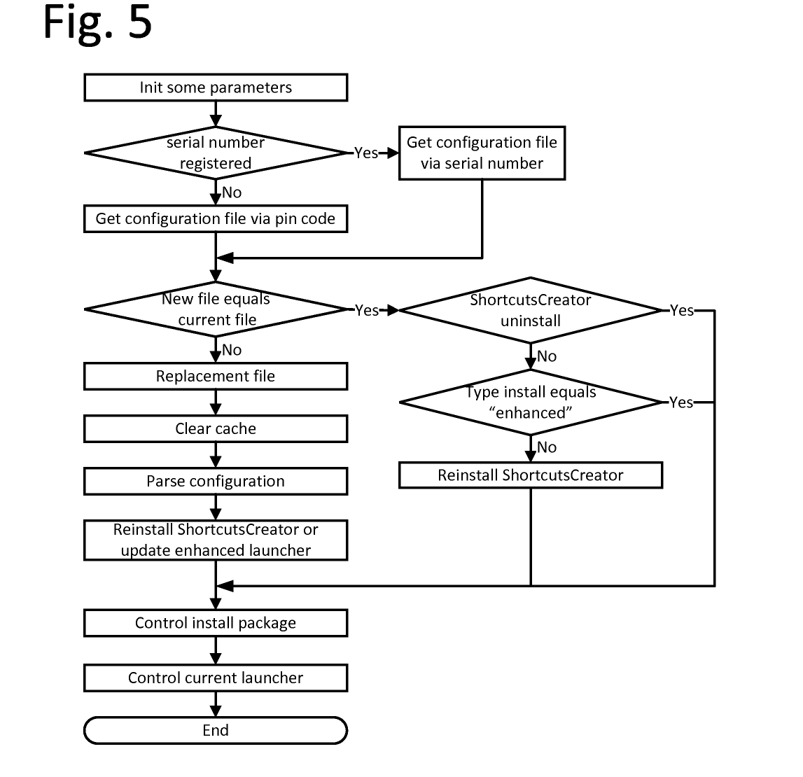

An exemplary general method for a downloader that may be used to download data from the cloud server 50 to the device 40 is depicted in FIG. 3. An exemplary process for controlling installation of packages and shortcuts of the method of FIG. 3 is depicted in FIG. 4 and an exemplary process for checking updates of the method of FIG. 3 is depicted in FIG. 5.

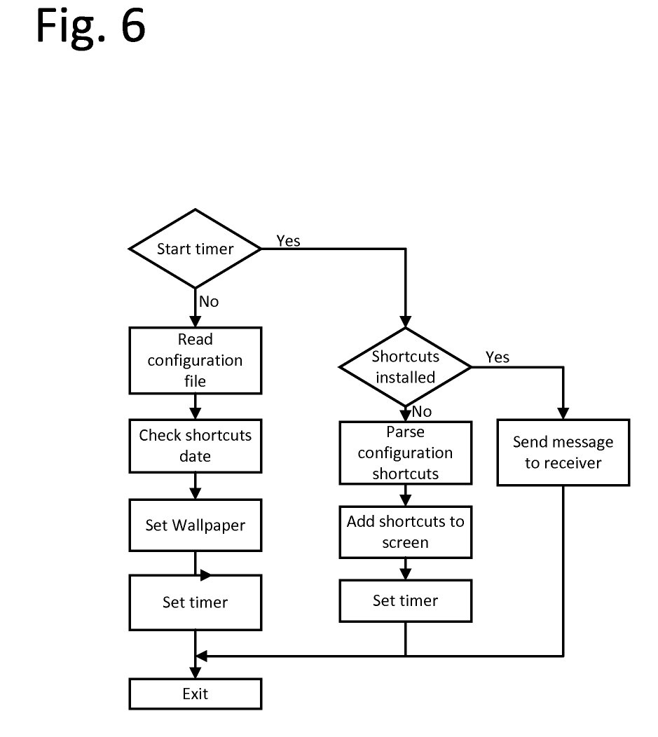

The exemplary downloader of FIGS. 3-5 may install and create a shortcut creator, e.g., configured to create shortcuts, or placeholders, on the graphical user interface of the exemplary device 40. An exemplary method for a shortcuts creator is depicted in FIG. 6. Additionally, although not depicted, when a placeholder that is a URL shortcut is launched, the shortcut creator may call a default browser and open the URL.

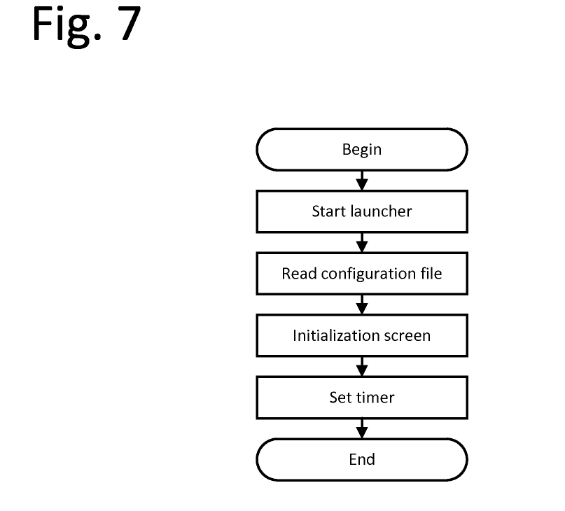

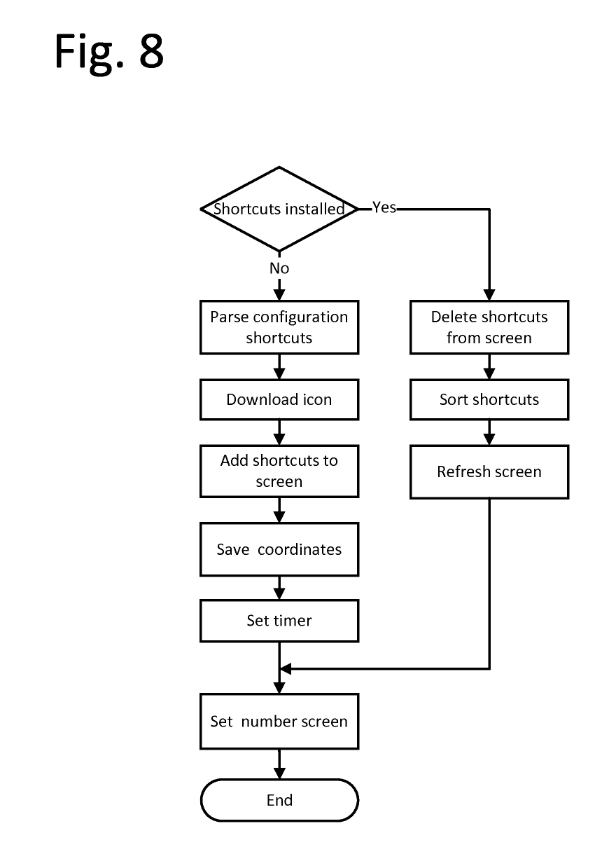

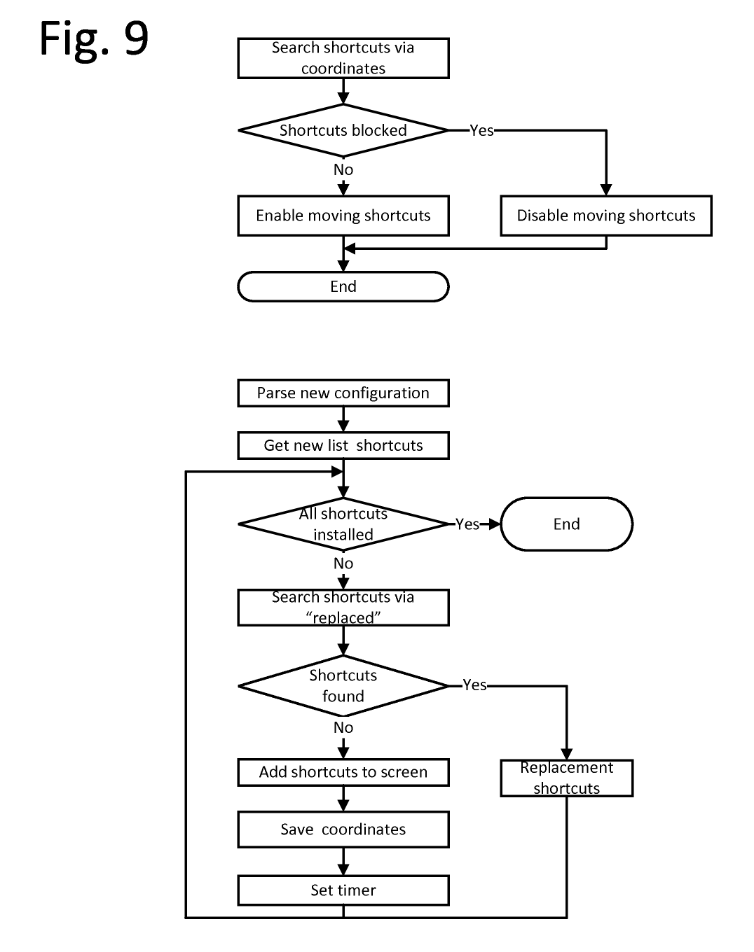

When a placeholder or application is launched, a launcher may be initiated. An exemplary method for a launcher is depicted in FIG. 7, and exemplary processes called, or initiated, by the launcher such as a timer and processes for blocked shortcuts and updating shortcuts are depicted in FIGS. 8-9, respectively. Generally, when a placeholder or app shortcut is selected (e.g., touched, clicked, etc.), a shortcut may be added to a queue, and if the shortcut is in the first place in the queue, then the launcher may call the shortcut creator, e.g., as depicted in FIG. 6. The shortcut creator may check whether it is an URL, or web, shortcut or app shortcut, and then check whether the app is installed. If the app is already installed, the launcher and/or shortcut creator may start, or initiate, the app. If the app is not installed, the downloader may be initiated or called, which may download, install, and start the app or APK as shown in FIGS. 3-5.

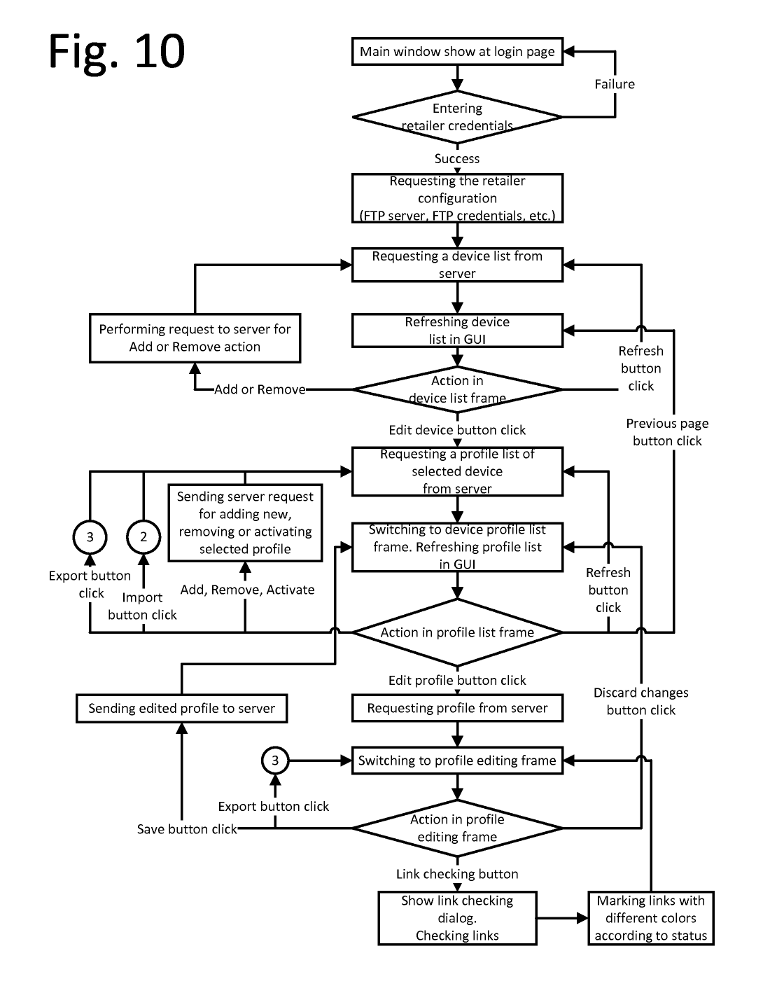

The retailer or enterprise may interface with the cloud server 50 to, e.g., modify or configure the plurality of graphical elements associated with the retailer or enterprise to be shown on the one or more users' devices. For example, a retailer or enterprise (e.g., an administrator working for the retailer or enterprise) may be allowed to select what graphical elements may be shown, where the graphical elements may be shown on the user interface, etc. Further, for example, a retailer or enterprise may be allowed to configure what graphical elements and/or applications represented thereby may be updated to newer versions. An exemplary method for a desktop application for administering an account for a retailer or enterprise is depicted in FIG. 10.

One or more process steps shown in FIGS. 1-10 may be used to implement the custom user interface on device 40 to provide the user interface upon first usage and one or more of the process steps may be used for updating the custom user interface on device 40.

In one or more embodiments of the present disclosure, the system may be implemented using one or more computer programs executed on programmable computers, such as computers that include, for example, processing capabilities, data storage (e.g., volatile or non-volatile memory and/or storage elements), input devices, and output devices. Program code and/or logic described herein may be applied to input data to perform functionality described herein and generate desired output information. The output information may be applied as input to one or more other devices and/or processes as described herein or as would be applied in a known fashion.

One or more programs used to implement the present invention may be provided using any programmable language, e.g., a high level procedural and/or object orientated programming language that is suitable for communicating with a computer system. Any such programs may, for example, be stored on any suitable device, e.g., a storage media, readable by a general or special purpose program, computer or a processor apparatus for configuring and operating the computer when the suitable device is read for performing the procedures described herein. In other words, at least in one embodiment, the system may be implemented using a computer readable storage medium, configured with a computer program, where the storage medium so configured causes the computer to operate in a specific and predefined manner to perform functions described herein.

The exact configuration of any computing apparatus described herein is not limiting and essentially any device capable of providing suitable computing capabilities may be used according to the present disclosure. Further, various peripheral devices, such as a computer display, mouse, keyboard, memory, printer, scanner, are contemplated to be used in combination with any computer apparatus herein.

As described herein, a digital file (e.g., for storing processes, methods, instructions, programs, data, configurations, graphical elements, icons, APKs, applications, apps, passwords, PINs, serial numbers, retailer/enterprise preferences, etc.) may be stored on any non-transitory medium (e.g., volatile or non-volatile memory, a CD-ROM, a punch card, magnetic recordable tape, etc.) containing digital bits (e.g., encoded in binary, trinary, etc.) that may be readable and/or writeable by processing apparatus described herein.

Also, as described herein, a file in user-readable format may be any representation of data (e.g., ASCII text, binary numbers, hexadecimal numbers, decimal numbers, audio, graphical) presentable on any medium (e.g., paper, a display, sound waves, etc.) readable and/or understandable by a user.

In view of the above, it will be readily apparent that the functionality as described in one or more embodiments according to the present disclosure may be implemented in any manner as would be known to one skilled in the art. As such, the computer language, the computer system, or any other software/hardware which is to be used to implement the present embodiments shall not be limiting on the scope of the processes or programs (e.g., the functionality provided by such processes or programs) described herein.

All references cited herein are incorporated in their entirety as if each were incorporated separately. This present disclosure has been described with reference to illustrative embodiments and is not meant to be construed in a limiting sense. Various modifications of the illustrative embodiments, as well as additional embodiments, will be apparent to persons skilled in the art upon reference to this description.

1. A method of providing a custom user interface on a computer device, wherein the computer device comprises memory, a screen, and a processing apparatus, wherein the method comprises:
providing a server comprising memory and processing apparatus, wherein the server memory comprises information associated with one or more enterprises, wherein the information comprises at least identification information corresponding to each of the one or more enterprises and a plurality of graphical elements associated with each of the one more enterprises to be delivered to a defined location on a screen of a computer device, each of the one or more of the graphical elements being associated with a web address or an address of the server;
providing a user interface installation program storable on memory of a computer device;
communicating with the server, using the user interface installation program, to identify an enterprise of the one or more enterprises as being associated with the computer device based at least on the identification information; and
downloading and placing a plurality of graphical elements associated with the identified enterprise at a defined location on a screen of the computer device, one or more of the plurality of graphical elements placed at the defined location on the screen operating as placeholders corresponding to downloadable device applications, wherein interaction, by a user of the computer device, with a graphical element operating as a placeholder initiates downloading the downloadable device application corresponding to the placeholder.

2-3. (canceled)

4. The method of claim 1, wherein the computer device comprises one of a tablet computer device and a mobile phone.

5. The method of claim 1, wherein the enterprise is a retailer.

6. The method of claim 1, wherein one or more of the plurality of graphical elements placed at the defined location on the screen operating as placeholders corresponding to downloadable device applications are non-removable.

7. The method of claim 1, wherein the computer device, using the user interface installation program, calls back and reconnects with the server on a periodic or non-periodic basis to monitor and/or update the plurality of graphical elements associated with the identified enterprise.

8. The method of claim 7, wherein the update may include updating perpetual graphical elements, adding new graphical elements, and/or removing expired/old graphical elements.

9. The method of claim 1, wherein downloading and placing the plurality of graphical elements associated with the identified enterprise at a defined location on a screen of the computer device is provided without user intervention.

10. The method of claim 1, wherein at least one of the plurality of graphical elements is auto-launched to convert the graphical element placed at the defined location on the screen operating as a placeholder to a device application upon first interaction with the graphical element by a user, an icon associated with the device application and identical to the graphical element replacing the graphical element after such first interaction.

11. The method of claim 1, wherein the computer device, using the user interface installation program, provides a screen on the computer device that comprises:
a retailer space, wherein the retailer space displays a plurality of graphical elements associated with the retailer; and
a user space separate from the retailer space, wherein the user space displays one or more icons corresponding to user selected applications at the same time the plurality of graphical elements associated with the retailer are displayed.

12. (canceled)

13. A computer tablet device or a mobile phone, each comprising a screen, wherein the screen comprises:
an enterprise space, wherein the enterprise space displays a plurality of graphical elements associated with the enterprise, one or more of the plurality of graphical elements operating as placeholders corresponding to downloadable device applications; and
a user space, wherein the user space displays one or more icons corresponding to user selected applications.

14. A system of providing a custom user interface on a computer device, wherein the computer device comprises memory, a screen, and a processing apparatus, wherein the system comprises:
a server comprising memory and processing apparatus, wherein the server memory comprises information associated with one or more enterprises, wherein the information comprises at least identification information corresponding to each of the one or more enterprises and a plurality of graphical elements associated with each of the one more enterprises to be delivered to a defined location on a screen of a computer device, each of the one or more graphical elements being associated with a web address or an address of the server; and
a user interface installation program storable on memory of a computer device, wherein the user interface installation program, when executed by a processing apparatus of the computer device, is operable to:
identify an enterprise of the one or more enterprises as being associated with the computer device via communication with the server based at least on the identification information;
communicate with the server to download and place a plurality of graphical elements associated with an identified enterprise at a defined location on a screen of the computer device, one or more of the plurality of graphical elements placed at a defined location on the screen operating as placeholders corresponding to downloadable device applications; and
download a downloadable device application corresponding to a placeholder upon user interaction with a graphical element operating as the placeholder.

15. The system of claim 14, wherein the computer device comprises one of a tablet computer device and a mobile phone.

16. The system of claim 14, wherein one or more of the plurality of graphical elements placed at the defined location on the screen operating as placeholders corresponding to downloadable device applications are non-removable.

17. The system of claim 14, wherein the computer device, using the user interface installation program, calls back and reconnects with the server on a periodic or non-periodic basis to monitor and/or update the plurality of graphical elements associated with the identified enterprise.

18. The system of claim 14, wherein downloading and placing the plurality of graphical elements associated with the identified enterprise at a defined location on a screen of the computer device is provided without user intervention.

19. The system of claim 14, wherein at least one of the plurality of graphical elements is auto-launched to convert the graphical element placed at the defined location on the screen operating as a placeholder to a device application upon first interaction with the graphical element by a user, an icon associated with the device application and identical to the graphical element replacing the graphical element after such first interaction.

20. The system of claim 14, wherein the computer device, using the user interface installation program, provides a screen on the computer device that comprises:
a retailer space, wherein the retailer space displays a plurality of graphical elements associated with the retailer; and
a user space separate from the retailer space, wherein the user space displays one or more icons corresponding to user selected applications at the same time the plurality of graphical elements associated with the retailer are displayed.

21. A system of providing a custom user interface on a computer device, wherein the computer device comprises memory, a screen, and a processing apparatus, wherein the system comprises:
a server comprising memory and processing apparatus, wherein the server memory comprises information associated with one or more enterprises, wherein the information comprises at least identification information corresponding to each of the one or more enterprises and a plurality of graphical elements associated with each of the one more enterprises to be delivered to a defined location on a screen of a computer device, each of the one or more graphical elements being associated with a web address or an address of the server; and
a user interface installation program storable on memory of a computer device, wherein the user interface installation program, when executed by a processing apparatus of the computer device, is operable to:
identify an enterprise of the one or more enterprises as being associated with the computer device via communication with the server based at least on the identification information;
communicate with the server to download and place a plurality of graphical elements associated with an identified enterprise at a defined location on a screen of the computer device, one or more of the plurality of graphical elements placed at a defined location on the screen operating as placeholders corresponding to downloadable device applications; and
download a downloadable device application corresponding to a placeholder upon user interaction with a graphical element operating as the placeholder.

22. The system of claim 21, wherein one or more of the plurality of graphical elements placed at the defined location on the screen operating as placeholders corresponding to downloadable device applications are non-removable.

23. The system of claim 21, wherein the computer device, using the user interface installation program, calls back and reconnects with the server on a periodic or non-periodic basis to monitor and/or update the plurality of graphical elements associated with the identified enterprise.

24. The system of claim 21, wherein downloading and placing the plurality of graphical elements associated with the identified enterprise at a defined location on a screen of the computer device is provided without user intervention.
